(19) United States
(12) Patent Application Publication
(10) Pub. No.: US 2023/0155113 A1
(43) Pub. Date: May 18, 2023

(54) LITHIUM MANGANESE OXIDE PARTICLES AND METHODS OF MAKING THE SAME

(71) Applicant: GM GLOBAL TECHNOLOGY OPERATIONS LLC, Detroit, MI (US)

(72) Inventors: Jingyuan LIU, Shanghai (CN); Haijing LIU, Shanghai (CN); Mark W. VERBRUGGE, Troy, MI (US); Meiyuan WU, Shanghai (CN)

(73) Assignee: GM GLOBAL TECHNOLOGY OPERATIONS LLC, Detroit, MI (US)

(21) Appl. No.: 17/832,376

(22) Filed: Jun. 3, 2022

(30) Foreign Application Priority Data
Nov. 12, 2021 (CN) 202111338021.0

(51) Int. Cl. H01M 4/36; H01M 4/505; H01M 10/0525

(52) U.S. Cl. CPC H01M 4/366; H01M 4/505; H01M 10/0525; H01M 2004/028

(57) ABSTRACT

Lithium manganese oxide (LMO) particles having a substantially round shape and methods of preparing such LMO particles are provided herein. The method includes, in the presences of a catalyst, calcining (i) a lithium source and a manganese source and/or (ii) a lithium and manganese source to form the LMO particles. Examples of the lithium source include Li₂CO₃, LiOH, LiNO₃, Li₂O, and combinations thereof, and examples of the manganese source include MnO₂, Mn₃O₄, and a combination thereof. The lithium and manganese source includes LiₓMn₂O₄, where 0.75≤x≤1.25. The catalyst includes one or more transition metal, such as a period 5 transition metal, a period 6 transition metal, a period 7 transition metal, and a combination thereof, an oxide of the one or more transition metal, a salt of the one or more transition metal, or a combination thereof.

### CROSS REFERENCE TO RELATED APPLICATIONS

This application claims the benefit and priority of Chinese Application No. 202111338021.0 filed Nov. 12, 2021. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a relatively high concentration of intercalated lithium, which is oxidized into lithium ions and electrons. The lithium ions travel from the negative electrode (anode) to the positive electrode (cathode), for example, through the ionically conductive electrolyte solution contained within the pores of an interposed porous separator. At the same time, the electrons pass through the external circuit from the negative electrode to the positive electrode. The lithium ions may be assimilated into the material of the positive electrode by an electrochemical reduction reaction. The battery may be recharged after a partial or full discharge of its available capacity by an external power source, which reverses the electrochemical reactions that transpired during discharge.

Lithium manganese oxide (LMO), such as LiMn₂O₄, is attractive as electroactive materials for positive electrodes for lithium-ion batteries because its high rate performance especially under cold climate and are less expensive than other commercially available cathode materials.

In spite of the advantages of LMO materials, there remains fundamental challenges limiting its commercial application. For example, due to the John-Taller effect, manganese dissolution may occur during cycling wherein manganese may be dissolve into the electrolyte thus causing consumption of electroactive material and undesirable capacity fade. This manganese dissolution is more likely to occur with LMO materials having an octahedron shape, particularly at the corner and edge of the octahedron shape, due to the abundant dangling bonds existing in those areas. Additionally, LMO materials with an octahedron shape can experience undesirable non-uniform current distribution, which may lead to the non-uniform aging within LMO particles in aged electrochemical cells.

It would be desirable to develop LMO materials for lithium ion batteries, which overcome the current shortcomings. Accordingly, it would be desirable to develop materials for lithium ion batteries, particularly LMO materials for positive electrodes having a round shape, which exhibit uniform electrochemical behavior and improved cycling stability.

### SUMMARY

This section provides a general summary of the disclosure and is not a comprehensive disclosure of its full scope or all of its features.

In certain aspects, the present disclosure provides a method of preparing lithium manganese oxide particles. The method includes, in the presence of a catalyst, calcining (i) a lithium source and a manganese source and/or (ii) a lithium and manganese source to form the lithium manganese oxide particles. The lithium source may be Li₂CO₃, LiOH, LiNO₃, Li₂O, or a combination thereof. The manganese source may be MnO₂, Mn₃O₄, or a combination thereof. The lithium and manganese source may include LiₓMn₂O₄, where 0.75≤x≤1.25. The catalyst may include one or more transition metal, such as a period 5 transition metal, a period 6 transition metal, a period 7 transition metal, or a combination thereof, an oxide of the one or more transition metal, a salt of the one or more transition metal, or a combination thereof. For example, the catalyst may include Zr, Nb, W, Ag, Ta, La, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof. The lithium manganese oxide particles may have a substantially round shape.

The catalyst may be added in an amount of about 0.05 wt % to about 8 wt %, based on total weight of the lithium and manganese source and the catalyst.

The calcining may be performed at a temperature of greater than or equal to about 400° C.

The substantially round shape of the lithium manganese oxide particles may be a sphere or an oblate spheroid. Additionally or alternatively, the substantially round shape of the lithium manganese oxide particles may include a flat surface.

The method may further include forming a metal oxide layer on at least a portion of a surface of the lithium manganese oxide particles. The metal oxide layer may include Al₂O₃, ZrO₂, MgO, or a combination thereof.

The lithium manganese oxide particles can include a lithium manganese core particle including LiₓMn₂O₄, where 0.75≤x≤1.25 and a catalyst particle present on a surface of the lithium manganese core particle. The catalyst particle may include one or more transition metal, such as a period 5 transition metal, a period 6 transition metal, a period 7 transition metal, or a combination thereof, an oxide of the one or more transition metal, a salt of the one or more transition metal, or a combination thereof. Additionally or alternatively, the lithium manganese oxide particles can include the lithium manganese core particle and a catalyst particle layer present on at least a portion of the surface of the lithium manganese core particle. Additionally or alternatively, the lithium manganese oxide particles can include the lithium manganese core particle discrete from the catalyst particle. Additionally or alternatively, the lithium manganese oxide particles can include the lithium manganese core particle with the catalyst particle present on the surface of the lithium manganese core particle and a metal oxide layer, such as Al₂O₃, ZrO₂, and/or MgO, surrounding at least a portion of the surface of the lithium manganese core particle and a surface of the catalyst particle. Additionally or alternatively, the lithium manganese oxide particles can include the lithium manganese core particle with a catalyst particle layer present on at least a portion of the surface of the lithium manganese core particle and the metal oxide layer present on at least a portion of a surface of the catalyst particle layer. Additionally or alternatively, the lithium manganese oxide particles can include the lithium manganese core particle with the metal oxide layer present on at least a portion of a surface of the lithium manganese core particle and a discrete catalyst particle with the metal oxide layer present on at least a portion of a surface of the catalyst particle.

In yet other aspects, the present disclosure provides lithium manganese oxide particles. The lithium manganese oxide particles may include a lithium manganese core particle including LiₓMn₂O₄, where 0.75≤x≤1.25, and a catalyst particle including one or more transition metal, such as a period 5 transition metal, a period 6 transition metal, a period 7 transition metal, or a combination thereof, an oxide of the one or more transition metal, a salt of the one or more transition metal, or a combination thereof. For example, the catalyst particle may include Zr, Nb, W, Ag, Ta, La, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof. The lithium manganese oxide particles may have a substantially round shape.

The substantially round shape of the lithium manganese oxide particles may be a sphere or an oblate spheroid. Additionally or alternatively, the substantially round shape of the lithium manganese oxide particles may include a flat surface.

The lithium manganese oxide particles may further include a metal oxide layer on at least a portion of a surface of the lithium manganese oxide particles. The metal oxide layer may include Al₂O₃, ZrO₂, MgO, or a combination thereof.

The lithium manganese oxide particles may include the catalyst particle present on a surface of the lithium manganese core particle. Additionally alternatively, the lithium manganese oxide particles may include a catalyst particle layer present on at least a portion of the surface of the lithium manganese core particle. Additionally alternatively, the lithium manganese oxide particles may include the lithium manganese core particle discrete from the catalyst particle. Additionally alternatively, the lithium manganese oxide particles may include a metal oxide layer, such as Al₂O₃, ZrO₂, and/or MgO, present on at least a portion of the surface of the lithium manganese core particle and a surface of the catalyst particle. Additionally alternatively, the lithium manganese oxide particles may include the metal oxide layer present on at least a portion of a surface of the catalyst particle layer which is present on at least a portion of the lithium manganese core particle. Additionally alternatively, the lithium manganese oxide particles may include the lithium manganese core particle discrete from the catalyst particle, and the metal oxide layer present on at least a portion of a surface of the lithium manganese core particle and/or at least a portion of a surface of the discrete catalyst particle.

In yet other aspects, the present disclosure provides an electrochemical cell. The electrochemical cell includes a positive electrode including a first electroactive material. The first electroactive material includes lithium manganese oxide particles including a lithium manganese core particle including LiₓMn₂O₄, where 0.75≤x≤1.25, and a catalyst particle including one or more transition metal, such as a period 5 transition metal, a period 6 transition metal, a period 7 transition metal, and a combination thereof, an oxide of the one or more transition metal, an oxide of the one or more transition metal; a salt of the one or more transition metal, or a combination thereof. For example, the catalyst particle may include Zr, Nb, W, Ag, Ta, La, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof. The lithium manganese oxide particles may have a substantially round shape. The electrochemical cell may further include a negative electrode including a second electroactive material, wherein the positive electrode is spaced apart from the negative electrode, a porous separator disposed between confronting surfaces of the positive electrode and the negative electrode, and a liquid electrolyte infiltrating one or more of: the positive electrode, the negative electrode, and the porous separator.

The substantially round shape of the lithium manganese oxide particles may be a sphere or an oblate spheroid. Additionally or alternatively, the substantially round shape of the lithium manganese oxide particles may include a flat surface.

The lithium manganese oxide particles may further include a metal oxide layer on at least a portion of a surface of the lithium manganese oxide particles. The metal oxide layer may include Al₂O₃, ZrO₂, MgO, or a combination thereof.

The lithium manganese oxide particles may include the catalyst particle present on a surface of the lithium manganese core particle. Additionally alternatively, the lithium manganese oxide particles may include a catalyst particle layer present on at least a portion of the surface of the lithium manganese core particle. Additionally alternatively, the lithium manganese oxide particles may include the lithium manganese core particle discrete from the catalyst particle. Additionally alternatively, the lithium manganese oxide particles may include a metal oxide layer, such as Al₂O₃, ZrO₂, and/or MgO, present on at least a portion of the surface of the lithium manganese core particle and a surface of the catalyst particle. Additionally alternatively, the lithium manganese oxide particles may include the metal oxide layer present on at least a portion of a surface of the catalyst particle layer which is present on at least a portion of the lithium manganese core particle. Additionally alternatively, the lithium manganese oxide particles may include the lithium manganese core particle discrete from the catalyst particle, and the metal oxide layer present on at least a portion of a surface of the lithium manganese core particle and/or at least a portion of a surface of the discrete catalyst particle.

The second electroactive material may include metallic lithium, a lithium alloy, silicon, graphite, activated carbon, carbon black, hard carbon, soft carbon, graphene, tin oxide, aluminum, indium, zinc, germanium, silicon oxide, titanium oxide, lithium titanate, or a combination thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C are each exemplary illustrations of a lithium manganese oxide (LMO) particle according to various aspects of the present disclosure.

FIGS. 2A-2H are each exemplary cross-sectional views of a LMO particle according to various aspects of the present disclosure.

FIG. 3 is a schematic of an exemplary electrochemical battery cell.

FIG. 4 is a schematic of an exemplary battery.

FIG. 5A is a scanning electron microscope (SEM) image of a LMO particle prepared according to a conventional method.

FIG. 5B is an SEM image of a LMO particle prepared according to a method of the present disclosure.

FIG. 6A is a simulated image of overpotential distribution of conventional angular LMO particles.

FIG. 6B is a simulated image of overpotential distribution of round LMO particles in accordance with the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” “attached to,” or “coupled to” another element or layer, it may be directly on, engaged, connected, attached or coupled to the other component, element, or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

### I. Lithium Manganese Oxide (LMO) Particles and Methods of Making the Same

Lithium manganese oxide (LMO) particles having a substantially round shape and methods for achieving such LMO particles having a substantially round shape are provided herein. Conventionally known methods of producing LMO particles typically produce LMO particles having an angular shape, such as an octahedron. This octahedron shape can result in increased manganese dissolution during battery operation thus causing undesirable capacity fade of the battery. Additionally, LMO particles with an octahedron shape can further experience a non-uniform current distribution across the LMO particles during cycling resulting in increased stress and cracking of the LMO particles leading to battery failure. In contrast, LMO particles having a substantially round shape may experience reduced manganese dissolution in part due to the lack of edges or corners of the round shape. Furthermore, LMO particles having a substantially round shape can experience a uniform current distribution across the LMO particles during cycling thus avoiding undesirable stress and cracking of the LMO particles.

It has been discovered that LMO particles having a substantially round shape can be prepared by heating or calcining a lithium source and a manganese source or a lithium and manganese source (also referred to as a combined lithium and manganese source) in the presence a catalyst as further described below. The lithium source, manganese source, and/or the lithium and manganese source may in the form of solid particles, such as a powder. In any embodiment, the lithium source may be Li₂CO₃, LiOH, LiNO₃, Li₂O, or any combination thereof. The manganese source may be MnO₂, Mn₃O₄, or a combination thereof. Additionally or alternatively, the lithium and manganese source, may include LiₓMn₂O₄, where 0.75≤x≤1.25, for example LiMn₂O₄. the

In any embodiment, the catalyst may include one or more suitable transition metals. As used herein, “transition metal” refers to metals in the d-block of the periodic table including groups 3 to 12 as well as the lanthanide series and actinoid series of elements. The term “transition metal” also encompasses post-transition metals, such as gallium (Ga), indium (In), tin (Sn), thalium (Tl), lead (Pb), and bismuth (Bi). For example, the catalyst may include one or more suitable transition metal selected from the group consisting of a period 5 transition metal, a period 6 transition metal, a period 7 transition metal, and a combination thereof. Period 5 transition metals include yttrium (Y), zirconium (Zr), niobium (Nb), molybdenum (Mo), technetium (Tc), ruthenium (Ru), rhodium (Rh), palladium (Pd), silver (Ag), cadmium (Cd), indium (In), tin (Sn), and antimony (Sb). Period 6 transition metals include lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), gold (Au), mercury (Hg), thallium (Tl), lead (Pb), and bismuth (Bi). Period 7 transition metals include actinide series elements, such as actinium (Ac), thorium (Th), protactinium (Pa), uranium (U), neptunium (Np), plutonium (Pu), Americium (Am), curium (Cm), berkelium (Bk), californium (Cf), einsteinium (Es), fermium (Fm), mendelevium (Md), nobelium (No), and lawrencium (Lr). In any embodiment, the catalyst may comprise transition metal particles, such as, but not limited to Y particles, Zr particles, Nb particles, W particles, Ag particles, Ta particles, La particles, and so on, and combinations thereof.

Additionally or alternatively, the catalyst may comprise an oxide of the one or more transition metals described herein and/or a salt of the one or more transition metals described herein. For example, the catalyst may comprise an oxide of one or more: period 5 transition metal as described above, period 6 transition metal as described above, and/or period 7 transition metal as described above. Examples of suitable salts of the one or more transition metals described herein include, but are not limited to, nitrate salts, carbonate salts, chloride salts, phosphate salts, and sulfate salts. In any embodiment, the catalyst may comprise, for example, in particle form, Zr, Nb, W, Ag, Ta, La, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof.

It is further contemplated herein that the catalyst described herein encompasses not only the transition metals described above and oxides and salts thereof but also includes any precursor material which forms the transition metals described above and oxides and salts thereof and any intermediate species formed therefrom. For example, Nb₂O₅ may be added as the catalyst along with a lithium source as described above and a manganese source as described above or a lithium and manganese source as described above. During the method, Nb₂O₅ may serve as a catalyst precursor, which reacts with the lithium source and form LiNbO₃ and LiNbO₃ may serve as the functional catalyst that causes the resultant LMO particles to have a round shape. The LMO particles formed may include LiNbO₃ particles as further described below. In another example, Mo may be added as a catalyst precursor along with a lithium source as described above and manganese source as described above or a lithium and manganese source as described above and MoO₂ may be formed as an intermediate during the process. MoO₂ has the potential to react with the manganese source to form MnMoO₄ and MnMoO₄ may serve as the functional catalyst that causes the resultant LMO particles to have a round shape. MnMoO₄ particles may be present in the LMO particles formed.

In any embodiment, the catalyst may be added in an amount, based on total weight of the lithium and manganese source and the catalyst, of greater than or equal to about 0.01 wt %, greater than or equal to about 0.05 wt %, greater than or equal to about 0.1 wt %, greater than or equal to about 0.25 wt %, greater than or equal to about 0.5 wt %, greater than or equal to about 1 wt %, greater than or equal to about 2 wt %, greater than or equal to about 4 wt %, greater than or equal to about 6 wt %, greater than or equal to about 8 wt %, or about 10 wt %; or from about 0.01 wt % to about 10 wt %, about 0.01 wt % to about 8 wt %, about 0.01 wt % to about 6 wt %, about 0.01 wt % to about 4 wt %, about 0.01 wt % to about 2 wt %, about 0.01 wt % to about 1 wt %, about 0.01 wt % to about 0.1 wt %, about 0.05 wt % to about 10 wt %, about 0.05 wt % to about 8 wt %, about 0.05 wt % to about 6 wt %, about 0.05 wt % to about 4 wt %, about 0.05 wt % to about 2 wt %, about 0.05 wt % to about 1 wt %, or about 0.05 wt % to about 0.1 wt %.

Additionally or alternatively, an amount of the catalyst, based on total weight of the LMO particles, may be greater than or equal to about 0.05 wt %, greater than or equal to about 0.1 wt %, greater than or equal to about 0.25 wt %, greater than or equal to about 0.5 wt %, greater than or equal to about 1 wt %, greater than or equal to about 2 wt %, greater than or equal to about 4 wt %, greater than or equal to about 6 wt %, greater than or equal to about 8 wt %, or about 10 wt %; or from about 0.05 wt % to about 10 wt %, about 0.05 wt % to about 8 wt %, about 0.05 wt % to about 6 wt %, about 0.05 wt % to about 4 wt %, about 0.05 wt % to about 2 wt %, about 0.05 wt % to about 1 wt %, about 0.05 wt % to about 0.1 wt %, about 0.1 wt % to about 10 wt %, about 0.1 wt % to about 8 wt %, about 0.1 wt % to about 6 wt %, about 0.1 wt % to about 4 wt %, about 0.1 wt % to about 2 wt %, or about 0.1 wt % to about 1 wt %.

In any embodiment, the lithium source, the manganese source, and/or the lithium and manganese source may be contacted and/or mixed with the catalyst for a suitable amount of time before, during, and after undergoing calcining. Calcining (or heating or annealing) may performed at a temperature of greater than or equal to about 300° C., greater than or equal to about 400° C., greater than or equal to about 500° C., greater than or equal to about 600° C., greater than or equal to about 700° C., greater than or equal to about 800° C., greater than or equal to about 900° C., greater than or equal to about 1000° C., or greater than or equal to about 1500° C.; or from about 300° C. to about 1500° C., about 300° C. to about 1000° C., about 300° C. to about 900° C., about 300° C. to about 800° C., about 300° C. to about 700° C., about 300° C. to about 600° C., about 300° C. to about 500° C., about 400° C. to about 1500° C., about 400° C. to about 4000° C., about 400° C. to about 900° C., about 400° C. to about 800° C., about 400° C. to about 700° C., about 400° C. to about 600° C., about 400° C. to about 500° C., about 500° C. to about 1000° C., about 600° C. to about 1000° C., about 700° C. to about 1000° C., about 800° C. to about 1000° C., or about 900° C. to about 1000° C. The calcining may be performed, for example, in an oven, for about 2 hours to about 20 hours.

Additionally or alternatively, the method described herein may further include forming a metal oxide layer on at least a portion of a surface of the lithium manganese oxide particles. The metal oxide layer may be formed by any suitable method for forming a thin film, for example, a dip coating method may be used or vapor deposition methods, such as atomic layer deposition (ALD) and chemical vapor deposition (CVD), may be used. The metal oxide layer may include Al₂O₃, ZrO₂, MgO, or a combination thereof.

In various aspects, LMO particles, for example, prepared according to the above described methods are provided herein. As described above, the LMO particles formed according to the methods described herein have an advantageously substantially round shape. The term “round shape” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes.

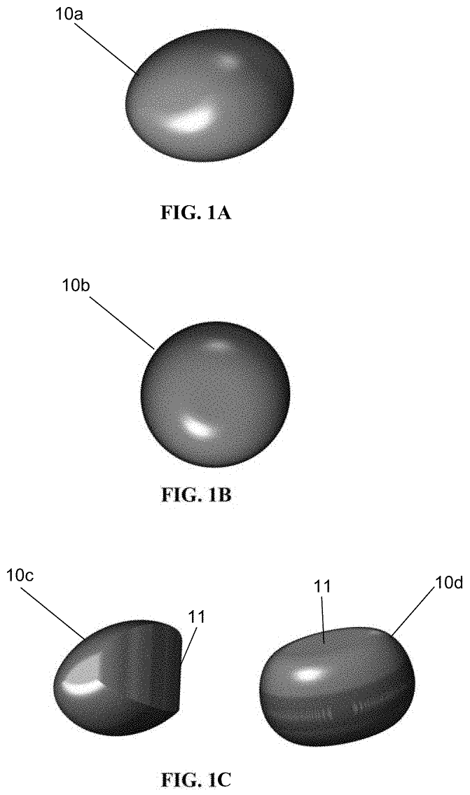

For example, as depicted in FIG. 1A, a LMO particle 10a may have e a substantially round shape that is an oblate spheroid or, as depicted in FIG. 1B, a LMO particle 10b may have a substantially round shape that is a sphere. Additionally or alternatively, as depicted in FIG. 1C, a LMO particle 10c, 10d, may include one or more flat surface 11 (also referred to as plane 11), for example, one, two, or three flat surface(s) 11. In any embodiment, the LMO particle may not be angular, hexagonal, and/or pyramidal.

In any embodiment, LMO particles may include a lithium manganese core particle comprising LiₓMn₂O₄, where 0.75≤x≤1.25, for example, LiMn₂O₄ (x=1), and catalyst particle(s). The catalyst particle(s) may include one or more transition metal selected from group consisting of a period 5 transition metal as described herein, a period 6 transition metal as described herein, a period 7 transition metal described herein, and a combination thereof. Additionally or alternatively, the catalyst particle(s) may include an oxide of the one or more transition metals described herein and/or a salt (e.g., nitrate salts, carbonate salts, chloride salts, phosphate salts, sulfate salts) of the one or more transition metals described herein. For example, the catalyst particle(s) may comprise an oxide of one or more: period 5 transition metal as described above, period 6 transition metal as described above, and/or period 7 transition metal as described above. In any embodiment, the catalyst particle(s) may comprise, for example, in particle form, Zr, Nb, W, Ag, Ta, la, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof. It is further contemplated herein that the catalyst particle(s) described herein encompass not only the transition metals described above and oxides and/or salts thereof but also any precursor material which forms the transition metals described above and oxides and/or salts thereof and any intermediate species formed therefrom.

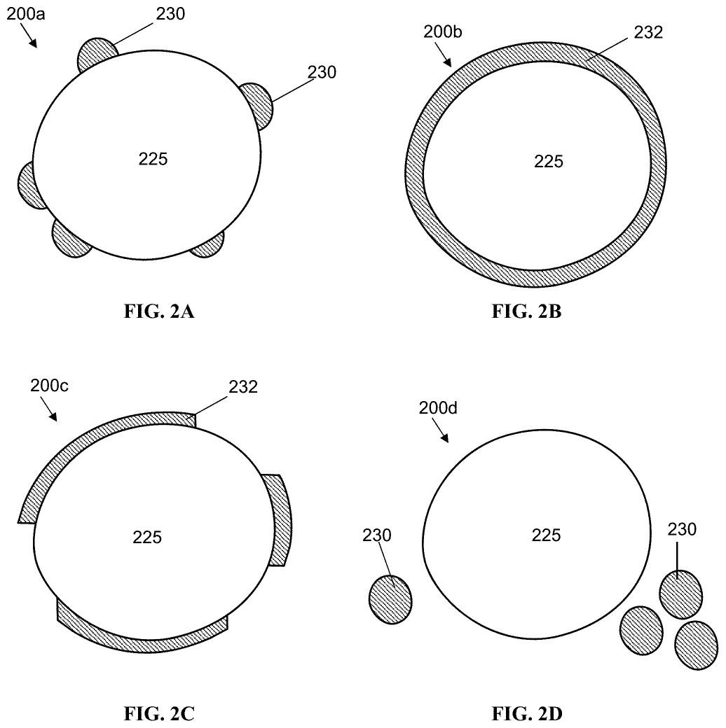

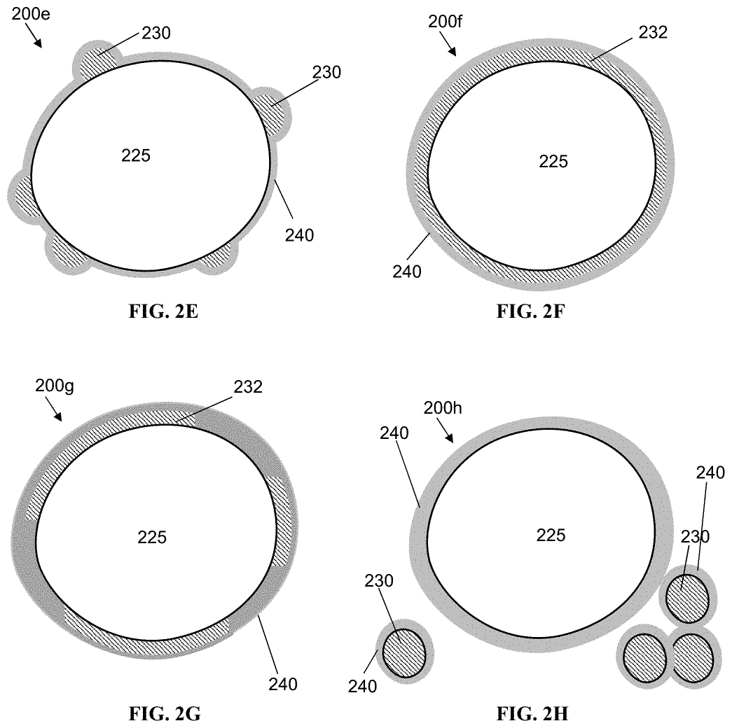

In various aspects, as depicted in FIGS. 2A-2H, the catalyst particle(s) may be distributed in various manners within the LMO particles. For example, as illustrated in FIG. 2A, LMO particle 200a includes catalyst particle(s) 230 present or disposed on a surface of a lithium manganese core particle 225. Additionally or alternatively, as illustrated in FIG. 2B, LMO particle 200b includes a catalyst particle layer 232 (i.e., a layer comprised of catalyst particles) present or disposed on a surface of a lithium manganese core particle 225. The catalyst particle layer 232 may be present as a continuous layer (FIG. 2B) on LMO particle 200b or as a discontinuous layer (FIG. 2C) on LMO particle 200c. Alternatively, as illustrated in FIG. 2D, LMO particle 200d includes a lithium manganese core particle 225 discrete from or separate from the catalyst particle(s) 230.

Additionally or alternatively, an LMO particle may include a metal oxide layer as described herein, for example, comprising Al₂O₃, ZrO₂, MgO, or a combination thereof. In any embodiment, the metal oxide layer may have thickness of greater than or equal to about 1 nm, greater than or equal to about 10 nm, greater than or equal to about 25 nm, greater than or equal to about 50 nm, greater than or equal to about 75 nm, greater than or equal to about 100 nm, greater than or equal to about 250 nm, or about 500 nm; or from about 1 nm to about 500 nm, about 1 nm to about 250 nm, about 1 nm to about 100 nm, about 1 nm to about 75 nm, about 1 nm to about 50 nm, about 1 nm to about 25 nm, or about 1 nm to about 10 nm.

As depicted in FIG. 2E, LMO particle 200e may include a metal oxide layer 240 as described herein present or disposed on at least a portion of the surface of the lithium manganese core particle 225 and a surface of the catalyst particle 230. Additionally or alternatively, as illustrated in FIG. 2F, LMO particle 200f may include a metal oxide layer 240 as described herein present or disposed on at least a portion of a surface of a catalyst particle layer 232, which is present on at least a portion of the lithium manganese core particle 225. As illustrated in FIG. 2G, LMO particle 200g may include a metal oxide layer 240 as described herein present or disposed on at least a portion of a surface of a catalyst particle layer 232, which is present or disposed on at least a portion of the lithium manganese core particle 225, as well as a metal oxide layer 240 present or disposed on a portion of the lithium manganese core particle 225. Alternatively, as illustrated in FIG. 2H, LMO particle 200h includes a lithium manganese core particle 225 discrete from or separate from the catalyst particle(s) 230, and a metal oxide layer 240 as described herein may be present or disposed on at least a portion of a surface of the lithium manganese core particle 225 and/or at least a portion of a surface of the discrete catalyst particle 230. It is contemplated herein that the LMO particles described herein may include any combination of distributions of catalyst particles with lithium manganese core particles as described above.

In any embodiment, there is no catalyst particle present within the bulk lithium manganese core particle.

### II. Electrochemical Cell

Lithium-containing electrochemical cells typically include a negative electrode, a positive electrode, an electrolyte for conducting lithium ions between the negative and positive electrodes, and a porous separator between the negative electrode and the positive electrode to physically separate and electrically insulate the electrodes from each other while permitting free ion flow. When assembled in an electrochemical cell, for example, in a lithium-ion battery, the porous separator is infiltrated with a liquid electrolyte. It has been discovered that LMO particles prepared according to the methods described herein may have a substantially round shape and can improve electrode performance. For example, the electrode can demonstrate a higher capacity retention rate as well as more structural stability.

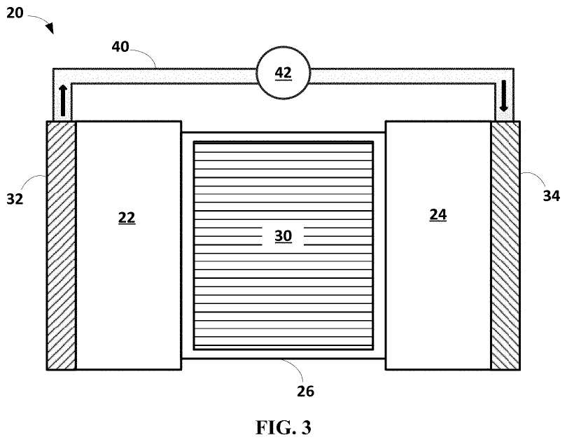

An electrochemical cell for use in a battery, for example, a lithium ion battery, or as a capacitor is provided herein. For example, an exemplary and schematic illustration of an electrochemical cell (also referred to as the lithium ion battery or battery) 20 is shown in FIG. 3. Electrochemical cell 20 includes a negative electrode 22 (also referred to as a negative electrode layer 22), a positive electrode 24 (also referred to as a positive electrode layer 24), and a separator 26 (e.g., a microporous polymeric separator) disposed between the two electrodes 22, 24. The space between (e.g., the separator 26) the negative electrode 22 and positive electrode 24 can be filled with the electrolyte 30. If there are pores inside the negative electrode 22 and positive electrode 24, the pores may also be filled with the electrolyte 30. The electrolyte 30 can impregnate, infiltrate, or wet the surfaces of and fill the pores of each of the negative electrode 22, the positive electrode 24, and the porous separator 26. A negative electrode current collector 32 may be positioned at or near the negative electrode, 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load device 42 connects the negative electrode 22 (through its current collector 32) and the positive electrode 24 (through its current collector 34). Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the battery 20. The separator 26 also contains the electrolyte solution in a network of open pores during the cycling of lithium ions, to facilitate functioning of the battery 20.

The battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of inserted lithium. The chemical potential difference between the positive electrode 24 and the negative electrode 22 drives electrons produced by the oxidation of inserted lithium at the negative electrode 22 through the external circuit 40 toward the positive electrode 24. Lithium ions, which are also produced at the negative electrode, are concurrently transferred through the electrolyte 30 and separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the inserted lithium in the negative electrode 22 is depleted and the capacity of the lithium ion battery 20 is diminished.

The lithium ion battery 20 can be charged or re-powered/re-energized at any time by connecting an external power source to the lithium ion battery 20 to reverse the electrochemical reactions that occur during battery discharge. The connection of an external power source to the lithium ion battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with inserted lithium for consumption during the next battery discharge event. As such, a complete discharging event followed by a complete charging event is considered to be a cycle, where lithium ions are cycled between the positive electrode 24 and the negative electrode 22. The external power source that may be used to charge the lithium ion battery 20 may vary depending on the size, construction, and particular end-use of the lithium ion battery 20. Some notable and exemplary external power sources include, but are not limited to, an AC wall outlet and a motor vehicle alternator.

In many battery configurations, each of the negative current collector 32, negative electrode 22, the separator 26, positive electrode 24, and positive current collector 34 are prepared as relatively thin layers (for example, several microns or a millimeter or less in thickness) and assembled in layers connected in electrical parallel arrangement to provide a suitable energy package. The negative electrode current collector 32 and positive electrode current collector 34 respectively collect and move free electrons to and from an external circuit 40.

Furthermore, the battery 20 can include a variety of other components that while not depicted here are nonetheless known to those of skill in the art. For instance, the lithium ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. The battery 20 shown in FIG. 1 includes a liquid electrolyte 30 and shows representative concepts of battery operation.

As noted above, the size and shape of the lithium ion battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium ion cells or batteries to produce a greater voltage output and power density if it is required by the load device 42.

Accordingly, the battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the battery 20 for purposes of storing energy.

The present technology pertains to improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

A. Positive Electrode

In various aspects, a lithium transition metal oxide electrode, such as positive electrode 24 (FIG. 1), is provided herein. The positive electrode 24 may be formed from a first electroactive material, such as a layered lithium transition metal oxide, that can sufficiently undergo lithium intercalation and deintercalation while functioning as the positive terminal of the lithium ion battery 20.

In any embodiment, the first electroactive material may include LMO particles as described herein having a substantially round shape. For example, the LMO particles may include a lithium manganese core particle comprising LiₓMn₂O₄, where 0.75≤x≤1.25 and a catalyst particle as described herein. The catalyst particle(s) may include one or more transition metal selected from the group consisting of a period 5 transition metal as described herein, a period 6 transition metal as described herein, a period 7 transition metal described herein, and combinations thereof. Additionally or alternatively, the catalyst particle(s) may include an oxide of the one or more transition metals described herein and/or a salt (e.g., nitrate salts, carbonate salts, chloride salts, phosphate salts, sulfate salts) of the one or more transition metals described herein. Additionally or alternatively, an LMO particle may include a metal oxide layer as described herein, for example, comprising Al₂O₃, ZrO₂, MgO, or a combination thereof.

Additionally or alternatively, the positive electrode 24 can optionally include an electrically conductive material and/or a polymeric binder. Examples of electrically conductive material include, but are not limited to, carbon black, graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), liquid metals (e.g., Ga, GaInSn), a conductive polymer (e.g., include polyaniline, polythiophene, polyacetylene, polypyrrole, and the like) and combinations thereof. As used herein, the term “graphene nanoplatelet” refers to a nanoplate or stack of graphene layers. Such electrically conductive material in particle form may have a round geometry or an axial geometry as described above.

As used herein, the term “polymeric binder” encompasses polymer precursors used to form the polymeric binder, for example, monomers or monomer systems that can form any one of the polymeric binders disclosed above. Examples of suitable polymeric binders, include but are not limited to, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), poly(acrylic acid) PAA, polyimide, polyamide, sodium alginate, lithium alginate, and combinations thereof. In some embodiments, the polymeric binder may be a non-aqueous solvent-based polymer or an aqueous-based polymer. In particular, the polymeric binder may be a non-aqueous solvent-based polymer that can demonstrate less capacity fade, provide a more robust mechanical network and improved mechanical properties to handle silicon particle expansion more effectively, and possess good chemical and thermal resistance. For example, the polymeric binder may include polyimide, polyamide, polyacrylonitrile, polyacrylic acid, a salt (e.g., potassium, sodium, lithium) of polyacrylic acid, polyacrylamide, polyvinyl alcohol, carboxymethyl cellulose, or a combination thereof. The first electroactive material may be intermingled with the electrically conductive material and/or at least one polymeric binder. For example, the first electroactive material and optional electrically conducting materials may be slurry cast with such binders and applied to a current collector. Polymeric binder can fulfill multiple roles in an electrode, including: (i) enabling the electronic and ionic conductivities of the composite electrode, (ii) providing the electrode integrity, e.g., the integrity of the electrode and its components, as well as its adhesion with the current collector, and (iii) participating in the formation of solid electrolyte interphase (SEI), which plays an important role as the kinetics of lithium intercalation is predominantly determined by the SEI.

In any embodiment, the first electroactive material may be present in the positive electrode in an amount, based on total weight of the positive electrode, of greater than or equal to about 80 wt. %, greater than or equal to about 90 wt. %, greater than or equal to about 91 wt. %, greater than or equal to about 92 wt. %, greater than or equal to about 93 wt. %, greater than or equal to about 94 wt. %, greater than or equal to about 95 wt. %, greater than or equal to about 96 wt. %, or about 98 wt. %; or from about 80 wt. % to about 98 wt. %, about 80 wt. % to about 96 wt. %, about 80 wt. % to about 95 wt. %, about 80 wt. % to about 94 wt. %, about 80 wt. % to about 93 wt. %, about 80 wt. % to about 92 wt. %, about 80 wt. % to about 90 wt. %, or about 90 wt. % to about 98 wt. %.

Additionally or alternatively, the electrically conductive material and the polymeric binder each may be independently present in the positive electrode in an amount, based on total weight of the positive electrode from about 0.5 wt. % to about 30 wt. %, about 1 wt. % to about 25 wt. %, about 1 wt. % to about 20 wt. %, about 1 wt. % to about 10 wt. %, about 3 wt. % to about 20 wt. %, or about 5 wt. % to about 15 wt. %.

B. Negative Electrode

The negative electrode 22 includes a second electroactive material as a lithium host material capable of functioning as a negative terminal of a lithium ion battery. The second electroactive material may be formed from or comprise metallic lithium. It is contemplated herein that the second electroactive material may be comprised of or consist of all metallic lithium (e.g., 100 wt. % lithium based on total weight of the first electroactive material). Additionally or alternatively, the second electroactive material may comprise a lithium alloy, such as, but not limited to, lithium silicon alloy, a lithium aluminum alloy, a lithium indium alloy, a lithium tin alloy, or combinations thereof. The negative electrode 22 may optionally further include one or more of graphite, activated carbon, carbon black, hard carbon, soft carbon, graphene, silicon, tin oxide, aluminum, indium, zinc, germanium, silicon oxide, titanium oxide, lithium titanate, and combinations thereof, for example, silicon mixed with graphite. Non-limiting examples of silicon-containing electroactive materials include silicon (amorphous or crystalline), or silicon containing binary and ternary alloys, such as Si—Sn, SiSnFe, SiSnAl, SiFeCo, and the like. In other variations, the negative electrode 22 may be a metal film or foil, such as a lithium metal film or lithium-containing foil. The second electroactive material may be in particle form and may have a round geometry or an axial geometry. The term “axial geometry” refers to particles generally having a rod, fibrous, or otherwise cylindrical shape having an evident long or elongated axis. Generally, an aspect ratio (AR) for cylindrical shapes (e.g., a fiber or rod) is defined as AR=L/D where L is the length of the longest axis and D is the diameter of the cylinder or fiber. Exemplary axial-geometry electroactive material particles suitable for use in the present disclosure may have high aspect ratios, ranging from about 10 to about 5,000, for example. In certain variations, the first electroactive material particles having an axial-geometry include fibers, wires, flakes, whiskers, filaments, tubes, rods, and the like. The term “round geometry” typically applies to particles having lower aspect ratios, for example, an aspect ratio closer to 1 (e.g., less than 10). It should be noted that the particle geometry may vary from a true round shape and, for example, may include oblong or oval shapes, including prolate or oblate spheroids, agglomerated particles, polygonal (e.g., hexagonal) particles or other shapes that generally have a low aspect ratio. Oblate spheroids may have disc shapes that have relatively high aspect ratios. Thus, a generally round geometry particle is not limited to relatively low aspect ratios and spherical shapes.

Additionally, the negative electrode 22 can optionally include an electrically conductive material as described herein and/or a polymeric binder as described herein that improves the structural integrity of the electrode. For example, the second electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), poly(acrylic acid) PAA, polyimide, polyamide, sodium alginate, or lithium alginate, and applied to a current collector. Examples of electrically conductive material include, but are not limited to, carbon black, graphite, acetylene black (such as KETCHEN™ black or DENKA™ black), carbon nanotubes, carbon fibers, carbon nanofibers, graphene, graphene nanoplatelets, graphene oxide, nitrogen-doped carbon, metallic powder (e.g., copper, nickel, steel or iron), liquid metals (e.g., Ga, GaInSn), a conductive polymer (e.g., include polyaniline, polythiophene, polyacetylene, polypyrrole, and the like) and combinations thereof.

In various aspects, the second electroactive material may be present in the negative electrode in an amount, based on total weight of the negative electrode from about 70 wt. % to about 100 wt. %, about 70 wt. % to about 98 wt. %, about 70 wt. % to about 95 wt. %, about 80 wt. % to about 95 wt. %. Additionally or alternatively, the electrically conductive material and the polymeric binder each may be independently present in the negative electrode in an amount, based on total weight of the negative electrode from about 0.5 wt. % to about 30 wt. %, about 1 wt. % to about 25 wt. %, about 1 wt. % to about 20 wt. %, about 1 wt. % to about 10 wt. %, about 3 wt. % to about 20 wt. %, or about 5 wt. % to about 15 wt. %.

C. Current Collectors

The positive electrode current collector 34 may be formed from aluminum (Al) or any other appropriate electrically conductive material known to those of skill in the art. The negative electrode current collector 32 may comprise a metal comprising copper, nickel, or alloys thereof, stainless steel, or other appropriate electrically conductive materials known to those of skill in the art. In certain aspects, the positive electrode current collector 34 and/or negative electrode current collector 32 may be in the form of a foil, slit mesh, and/or woven mesh.

D. Electrolyte

The positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G₃)(TFSI), lithium bis(trifluoromethanesulfonyl)azanide (LiTFSA), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane). One or more salts can be present in the electrolyte in a concentration ranging from about 1 M to about 4 M, for example, about 1 M, about 1 M to 2 M, or about 3 M to about 4 M. sulfur compounds (e.g., sulfolane), acetonitrile, and combinations thereof.

Additionally or alternatively, the electrolyte may include additives, which can, for example, increase temperature and voltage stability of the electrochemical cell materials (e.g., electrolyte 30, negative electrode 22, and positive electrode 24). Examples of suitable additives include, but are not limited to, vinyl carbonate, vinyl-ethylene carbonate, propane sulfonate, and combinations therefore. Other additives can include diluents which do not coordinate with lithium ions but can reduce viscosity, such as bis(2,2,2-trifluoroethyl) ether (BTFE), and flame retardants, such as triethyl phosphate.

E. Separator

The separator 26 may comprise, for example, a microporous polymeric separator comprising a polyolefin or PTFE. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes include CELGARD® 2500 (a monolayer polypropylene separator) and CELGARD® 2325 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26.

In various aspects, the porous separator 26 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24. By way of non-limiting example, SSEs may include LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof.

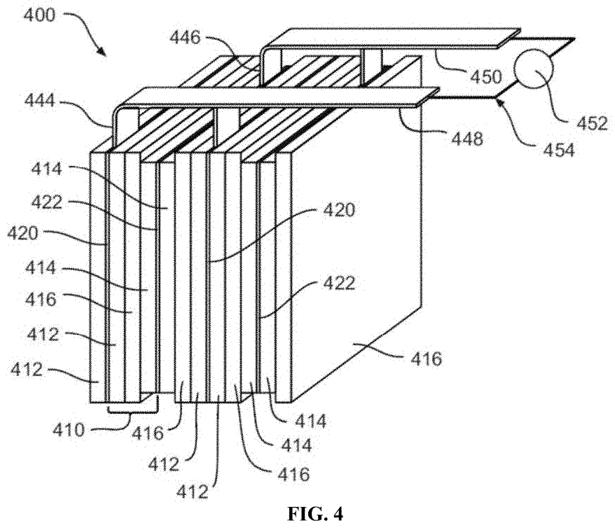

Referring now to FIG. 4, the electrochemical cell 20 (as shown in FIG. 3) may be combined with one or more other electrochemical cells to produce a lithium ion battery 400. The lithium ion battery 400 illustrated in FIG. 4 includes multiple rectangular-shaped electrochemical cells 410. Anywhere from 5 to 150 electrochemical cells 410 may be stacked side-by-side in a modular configuration and connected in series or parallel to form a lithium ion battery 400, for example, for use in a vehicle powertrain. The lithium ion battery 400 can be further connected serially or in parallel to other similarly constructed lithium ion batteries to form a lithium ion battery pack that exhibits the voltage and current capacity demanded for a particular application, e.g., for a vehicle. It should be understood the lithium ion battery 400 shown in FIG. 4 is only a schematic illustration, and is not intended to inform the relative sizes of the components of any of the electrochemical cells 410 or to limit the wide variety of structural configurations a lithium ion battery 400 may assume. Various structural modifications to the lithium ion battery 400 shown in FIG. 4 are possible despite what is explicitly illustrated.

Each electrochemical cell 410 includes a negative electrode 412 (e.g., negative electrode 22), a positive electrode 414 (e.g., positive electrode 24), and a separator 416 situated between the two electrodes 412, 414. Each of the negative electrode 412, the positive electrode 414, and the separator 416 is impregnated, infiltrated, or wetted with a liquid electrolyte (e.g., electrolyte 30) capable of transporting lithium ions. A negative electrode current collector 420 that includes a negative polarity tab 444 is located between the negative electrodes 412 of adjacent electrochemical cells 410. Likewise, a positive electrode current collector 422 that includes a positive polarity tab 446 is located between neighboring positive electrodes 424. The negative polarity tab 444 is electrically coupled to a negative terminal 448 and the positive polarity tab 446 is electrically coupled to a positive terminal 450. An applied compressive force usually presses the current collectors 420, 422, against the electrodes 412, 414 and the electrodes 412, 414 against the separator 416 to achieve intimate interfacial contact between the several contacting components of each electrochemical cell 410.

The battery 400 may include more than two pairs of positive and negative electrodes 412, 414. In one form, the battery 400 may include 15-60 pairs of positive and negative electrodes 412, 414. In addition, although the battery 400 depicted in FIG. 4 is made up of a plurality of discrete electrodes 412, 414 and separators 416, other arrangements are certainly possible. For example, instead of discrete separators 416, the positive and negative electrodes 412, 414 may be separated from one another by winding or interweaving a single continuous separator sheet between the positive and negative electrodes 412, 414. In another example, the battery 400 may include continuous and sequentially stacked positive electrode, separator, and negative electrode sheets folded or rolled together to form a “jelly roll.”

The negative and positive terminals 448, 450 of the lithium ion battery 400 are connected to an electrical device 452 as part of an interruptible circuit 454 established between the negative electrodes 412 and the positive electrodes 414 of the many electrochemical cells 410. The electrical device 452 may comprise an electrical load or power-generating device. An electrical load is a power-consuming device that is powered fully or partially by the lithium ion battery 400. Conversely, a power-generating device is one that charges or re-powers the lithium ion battery 400 through an applied external voltage. The electrical load and the power-generating device can be the same device in some instances. For example, the electrical device 452 may be an electric motor for a hybrid electric vehicle or an extended range electric vehicle that is designed to draw an electric current from the lithium ion battery 400 during acceleration and provide a regenerative electric current to the lithium ion battery 400 during deceleration. The electrical load and the power-generating device can also be different devices. For example, the electrical load may be an electric motor for a hybrid electric vehicle or an extended range electric vehicle and the power-generating device may be an AC wall outlet, an internal combustion engine, and/or a vehicle alternator.

The lithium ion battery 400 can provide a useful electrical current to the electrical device 452 by way of the reversible electrochemical reactions that occur in the electrochemical cells 410 when the interruptible circuit 454 is closed to connect the negative terminal 448 and the positive terminal 450 at a time when the negative electrodes 412 contain a sufficient quantity of intercalated lithium (i.e., during discharge). When the negative electrodes 412 are depleted of intercalated lithium and the capacity of the electrochemical cells 410 is spent. The lithium ion battery 400 can be charged or re-powered by applying an external voltage originating from the electrical device 452 to the electrochemical cells 410 to reverse the electrochemical reactions that occurred during discharge.

Although not depicted in the drawings, the lithium ion battery 400 may include a wide range of other components. For example, the lithium ion battery 400 may include a casing, gaskets, terminal caps, and any other desirable components or materials that may be situated between or around the electrochemical cells 410 for performance related or other practical purposes. For example, the lithium ion battery 400 may be enclosed within a case (not shown). The case may comprise a metal, such as aluminum or steel, or the case may comprise a film pouch material with multiple layers of lamination. It is contemplated herein that the electrochemical cell 20, 400 that is formed may be a pouch cell, coin cell, or another full electrochemical cell having a cylindrical format or wounded prismatic format.

### EXAMPLES

### Example 1

Round shaped LMO particles were synthesized by pre-mixing Li₂CO₃, MnO₂, and Nb₂O₅ (in a molar ratio of 2.1:1:0.0017) via milling, which were then transferred into an oven and calcined at a temperature under 850° C. for under 5 hours. Conventional angular LMO particles were synthesized by similar protocol as described above but without the addition of Nb₂O₅.

Further round shaped LMO particles were synthesized by pre-mixing Li₂CO₃, MnO₂ and Nb₂O₅ (in a molar ratio of 2.1:1:0.0034) via milling, which were then transferred into an oven and calcined at a temperature under 850° C. for under 2 hours. Conventional angular LMO particles were synthesized by a similar protocol as described above but without the addition of Nb₂O₅.

Further round shaped LMO particles were synthesized by pre-mixing Li₂CO₃, MnO₂ and Nb₂O₅ (in a molar ratio of 2.1:1:0.0017) via milling, which were then transferred into an oven and calcined at a temperature under 900° C. for under 2 hours. Conventional angular LMO particles were synthesized by a similar protocol as described above but without the addition of Nb₂O₅.

Further round shaped LMO particles were synthesized by pre-mixing Li₂CO₃, MnO₂ and Nb₂O₅ (in a molar ratio of 2.1:1:0.0034) via milling, which were then transferred into an oven and calcined at a temperature under 900° C. for under 5 hours. Conventional angular LMO particles were synthesized by a similar protocol as described above but without the addition of Nb₂O₅.

Further round shaped LMO particles were synthesized by pre-mixing Li₂CO₃, MnO₂ and Nb₂O₅ (in a molar ratio of 2.1:1:0.0017) via milling, which were then transferred into an oven and calcined at a temperature under 900° C. for under 10 hours. Conventional angular LMO particles were synthesized by a similar protocol as described above but without the addition of Nb₂O₅.

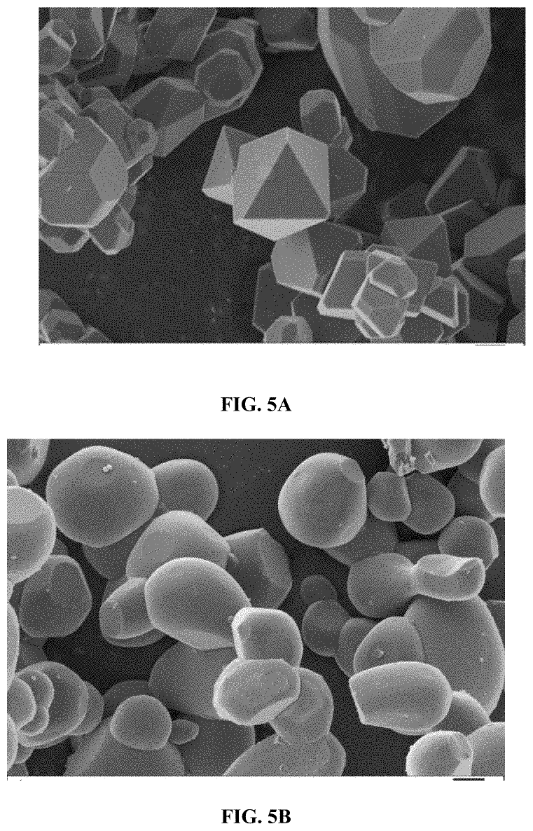

Conventional angular shaped LMO particles prepared according the present Example are shown in FIG. 5A and round shaped LMO particles prepared according the present Example are shown in FIG. 5B.

### Example 2

A simulation of round shaped LMO particles was performed by COMSOL Multiphysics, adopting LiMn₂O₄ as cathode and graphite as anode, the particle average diameter is 3*3.3*3.6 um, in 3-dimential orientations, the simulation process involved a 1C discharge with a duration of 90 s, starting from 50% SOC, involving 18 LMO particles. A simulation of angular shaped LMO particles having a double pyramid shape with an edge length of 3.3 um, with the other setting the same as the round shaped LMO particles was also performed.

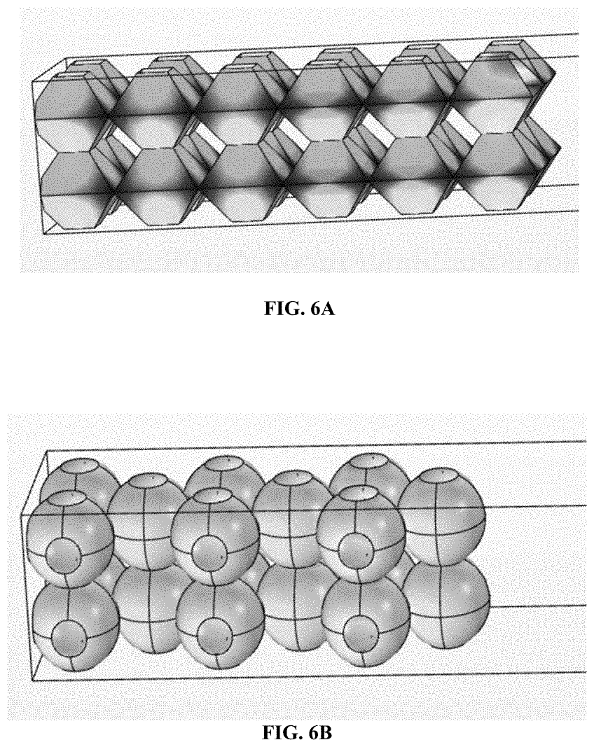

FIG. 6A is a simulated image of overpotential distribution of the conventional angular shaped LMO particles. FIG. 6B is a simulated image of overpotential distribution of the round shaped LMO particles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of preparing lithium manganese oxide particles, the method comprising:
in the presence of a catalyst, calcining (i) a lithium source and a manganese source and/or (ii) a lithium and manganese source to form the lithium manganese oxide particles;
wherein:
the lithium source is selected from the group consisting of Li₂CO₃, LiOH, LiNO₃, Li₂O, and a combination thereof;
the manganese source is selected from the group consisting of MnO₂, Mn₃O₄, and a combination thereof;
the lithium and manganese source comprises LiₓMn₂O₄, where 0.75≤x≤1.25;
the catalyst comprises:
one or more transition metal selected from group consisting of a period 5 transition metal, a period 6 transition metal, a period 7 transition metal, and a combination thereof;
an oxide of the one or more transition metal;
a salt of the one or more transition metal; or
a combination thereof; and
the lithium manganese oxide particles have a substantially round shape.

2. The method of claim 1, wherein the catalyst comprises Zr, Nb, W, Ag, Ta, La, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof.

3. The method of claim 1, wherein an amount of the catalyst added is about 0.05 wt % to about 8 wt %, based on total weight of the lithium and manganese source and the catalyst.

4. The method of claim 1, wherein the calcining is performed at a temperature of greater than or equal to about 400° C.

5. The method of claim 1, wherein the substantially round shape of the lithium manganese oxide particles is a sphere or an oblate spheroid.

6. The method of claim 1, wherein the substantially round shape of the lithium manganese oxide particles comprises a flat surface.

7. The method of claim 1, further comprising forming a metal oxide layer on at least a portion of a surface of the lithium manganese oxide particles, wherein the metal oxide layer comprises Al₂O₃, ZrO₂, MgO, or a combination thereof.

8. The method of claim 1, wherein the lithium manganese oxide particles comprises one or more of:
(i) a lithium manganese core particle comprising LiₓMn₂O₄, where 0.75≤x≤1.25 and a catalyst particle present on a surface of the lithium manganese core particle, wherein the catalyst particle comprises: one or more transition metal selected from group consisting of a period 5 transition metal, a period 6 transition metal, a period 7 transition metal, and a combination thereof; an oxide of the one or more transition metal; a salt of the one or more transition metal, or a combination thereof;
(ii) the lithium manganese core particle and a catalyst particle layer present on at least a portion of the surface of the lithium manganese core particle;
(iii) the lithium manganese core particle discrete from the catalyst particle;
(iv) the lithium manganese core particle with the catalyst particle present on the surface of the lithium manganese core particle and a metal oxide layer surrounding at least a portion of the surface of the lithium manganese core particle and a surface of the catalyst particle, wherein the metal oxide layer comprises Al₂O₃, ZrO₂, MgO, or a combination thereof;
(v) the lithium manganese core particle with a catalyst particle layer present on at least a portion of the surface of the lithium manganese core particle and the metal oxide layer present on at least a portion of a surface of the catalyst particle layer; and
(vi) the lithium manganese core particle with the metal oxide layer present on at least a portion of a surface of the lithium manganese core particle and a discrete catalyst particle with the metal oxide layer present on at least a portion of a surface of the catalyst particle.

9. Lithium manganese oxide particles comprising:
a lithium manganese core particle comprising LiₓMn₂O₄, where 0.75≤x≤1.25; and
a catalyst particle comprising: one or more transition metal selected from group consisting of a period 5 transition metal, a period 6 transition metal, a period 7 transition metal, and a combination thereof; an oxide of the one or more transition metal; a salt of the one or more transition metal; or a combination thereof;
wherein the lithium manganese oxide particles have a substantially round shape.

10. The lithium manganese oxide particles claim 9, wherein the catalyst particle comprises Zr, Nb, W, Ag, Ta, La, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof.

11. The lithium manganese oxide particles claim 9, wherein the substantially round shape of the lithium manganese oxide particles is a sphere or an oblate spheroid.

12. The lithium manganese oxide particles claim 9, wherein the substantially round shape of the lithium manganese oxide particles comprises a flat surface.

13. The lithium manganese oxide particles claim 9, further comprising a metal oxide layer on at least a portion of a surface of the lithium manganese oxide particles, wherein the metal oxide layer comprises Al₂O₃, ZrO₂, MgO, or a combination thereof.

14. The lithium manganese oxide particles claim 9, wherein one or more of the following is satisfied:
(i) the catalyst particle is present on a surface of the lithium manganese core particle;
(ii) a catalyst particle layer is present on at least a portion of the surface of the lithium manganese core particle;
(iii) the lithium manganese core particle is discrete from the catalyst particle;
(iv) a metal oxide layer is present on at least a portion of the surface of the lithium manganese core particle and a surface of the catalyst particle, wherein the metal oxide layer comprises Al₂O₃, ZrO₂, MgO, or a combination thereof;
(v) the metal oxide layer is present on at least a portion of a surface of the catalyst particle layer which is present on at least a portion of the lithium manganese core particle; and
(vi) the lithium manganese core particle is discrete from the catalyst particle and the metal oxide layer is present on at least a portion of a surface of the lithium manganese core particle and/or at least a portion of a surface of the discrete catalyst particle.

15. An electrochemical cell comprising:
a positive electrode comprising a first electroactive material comprising:
lithium manganese oxide particles comprising:
a lithium manganese core particle comprising LiₓMn₂O₄, where 0.75≤x≤1.25; and
a catalyst particle comprising: one or more transition metal selected from group consisting of a period 5 transition metal, a period 6 transition metal, a period 7 transition metal, and a combination thereof an oxide of the one or more transition metal; an oxide of the one or more transition metal; a salt of the one or more transition metal; or a combination thereof;
wherein the lithium manganese oxide particles have a substantially round shape;
a negative electrode comprising a second electroactive material, wherein the positive electrode is spaced apart from the negative electrode;
a porous separator disposed between confronting surfaces of the positive electrode and the negative electrode; and
a liquid electrolyte infiltrating one or more of: the positive electrode, the negative electrode, and the porous separator.

16. The electrochemical cell of claim 15, wherein the catalyst particle comprises Zr, Nb, W, Ag, Ta, La, ZrO₂, Nb₂O₃, Nb₂O₅, WO₃, La₂O₃, MnMoO₄, LiNbO₃, LaNbO₄, La(NO₃)₃, Zr₃(CO)₃O₅, or a combination thereof.

17. The electrochemical cell of claim 15, wherein the substantially round shape of the lithium manganese oxide particles is a sphere or an oblate spheroid and/or the substantially round shape of the lithium manganese oxide particles comprises a flat surface.

18. The electrochemical cell of claim 15, wherein the lithium manganese oxide particles further comprise a metal oxide layer on at least a portion of a surface of the lithium manganese oxide particles, wherein the metal oxide layer comprises Al₂O₃, ZrO₂, MgO, or a combination thereof.

19. The electrochemical cell of claim 15, wherein one or more of the following is satisfied:
(i) the catalyst particle is present on a surface of the lithium manganese core particle;
(ii) a catalyst particle layer is present on at least a portion of the surface of the lithium manganese core particle;
(iii) the lithium manganese core particle is discrete from the catalyst particle;
(iv) a metal oxide layer is present on at least a portion of the surface of the lithium manganese core particle and a surface of the catalyst particle, wherein the metal oxide layer comprises Al₂O₃, ZrO₂, MgO, or a combination thereof;
(v) the metal oxide layer is present on at least a portion of a surface of the catalyst particle layer which is present on at least a portion of the lithium manganese core particle; and
(vi) the lithium manganese core particle is discrete from the catalyst particle and the metal oxide layer is present on at least a portion of a surface of the lithium manganese core particle and/or at least a portion of a surface of the discrete catalyst particle.

20. The electrochemical cell of claim 15, wherein the second electroactive material comprises metallic lithium, a lithium alloy, silicon, graphite, activated carbon, carbon black, hard carbon, soft carbon, graphene, tin oxide, aluminum, indium, zinc, germanium, silicon oxide, titanium oxide, lithium titanate, or a combination thereof.
